(19) United States
(12) Patent Application Publication
(10) Pub. No.: US 2025/0154779 A1
(43) Pub. Date: May 15, 2025

(54) Interlocking Work Platform and System

(71) Applicant: Werner Co., Greenville, PA (US)

(72) Inventors: Fang Chen, Shanghai (CN); Liang He, Shanghai (CN); Ling Zhu, Shanghai (CN)

(21) Appl. No.: 19/020,584

(22) Filed: Jan. 14, 2025

Related U.S. Application Data
(63) Continuation of application No. 17/681,076, filed on Feb. 25, 2022.
(60) Provisional application No. 63/155,722, filed on Mar. 2, 2021.

(51) Int. Cl. E04G 1/30; E06C 1/393

(52) U.S. Cl. CPC E04G 1/30; E06C 1/393; E04G 2001/305

(57) ABSTRACT

A work platform system having a first work platform. The first work platform having a first hook assembly and a first latch assembly. The system having a second work platform. The second work platform having a second hook assembly and a second latch assembly. The first work platform locked to the second work platform through the first hook assembly engaging with the second latch assembly and the first hook assembly in the use position. A method for using a work platform system. A method for producing a work platform.

### CROSS-REFERENCE TO RELATED APPLICATIONS

This is a nonprovisional of U.S. provisional patent application Ser. No. 63/155,722 filed Mar. 2, 2021, incorporated by reference herein.

### FIELD OF THE INVENTION

The present invention pertains to a work platform system formed by connecting two work platforms together to move from one platform to the other without getting off either platform to do so. (As used herein, references to the “present invention” or “invention” relate to exemplary embodiments and not necessarily to every embodiment encompassed by the appended claims.) More specifically, the present invention pertains to a work platform system formed by connecting two work platforms together to move from one platform to the other without getting off either platform to do so where the work platforms are locked together with a sliding hook assembly.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Scaffolds are commonly used to provide artisans with the ability to work across longer elevated spaces than they otherwise could on a ladder. In many instances, the longer the elevated work spaces the better for the artisans because they then do not have to climb down off the work platform to move the work platform to a new location to access a new elevated workspace in which they need to work. One way to provide a longer elevated workspace is to provide for individual longer work platforms. However, the larger the work platform becomes, the heavier it becomes and the more effort is needed to move the work platform when needed.

Another way to accomplish a longer elevated space is to connect two or more individual work platforms together to effectively double the elevated workspace that would otherwise be available for only one workspace. However, when combining to individual work platforms together, care must be taken they are securely and safely connected, as well as they can be quickly and easily connected together.

### BRIEF SUMMARY OF THE INVENTION

The present invention pertains to a work platform system. The system comprises a first work platform. The first work platform comprises a first scaffold having a first end and a second end and a plane upon which a user can stand. The first work platform comprises a first leg assembly rotatably attached with bolts to the first end of the first scaffold having a first rail and a second rail and a rung attached to the first rail and the second rail. The first leg assembly in a folded position relative to the first scaffold and essentially in parallel the plane of the first scaffold. The first work platform comprises a second leg assembly rotatably attached with bolts to the second end of the first scaffold, the second leg assembly in an open position relative to the first scaffold and essentially perpendicular to the plane of the first scaffold. The first work platform comprises a first hook assembly slidingly attached to the first scaffold adjacent the first end which slides between a use position where the first hook assembly extends below and outward beyond the first scaffold between the first rail and the second rail of the first leg assembly and a stowed position where the first hook assembly is retracted below the first scaffold. The first work platform comprises a first latch assembly attached to the first scaffold adjacent the second end.

The work platform system comprises a second work platform. The second work platform comprises a second scaffold having a first end and a second end and a plane upon which the user can stand which is flat without objects on which the user can trip. The second work platform comprises a third leg assembly rotatably attached with bolts to the first end of the second scaffold having a first rail and a second rail and a rung attached to the first rail and the second rail of the third leg assembly, the third leg assembly in a closed position relative to the second scaffold and essentially in parallel to the plane of the second scaffold when the second scaffold is attached to the first scaffold. The second work platform comprises a fourth leg assembly rotatably attached with bolts to the second end of the second scaffold, the second leg assembly of the second scaffold in an open position relative to the second scaffold and essentially perpendicular to the plane of the second scaffold. The second work platform comprises a second hook assembly slidingly attached to the second scaffold adjacent the second end of the second scaffold which slides between a use position where the second hook assembly extends below and outward beyond the second scaffold between the first rail and the second rail of the fourth leg assembly and a stowed position where the first hook assembly is retracted below the first scaffold. The second work platform comprises a second latch assembly attached to the second scaffold adjacent the first end of the second scaffold. The first work platform locked to the second work platform through the first hook assembly engaging with the second latch assembly and the first hook assembly in the use position.

The present invention pertains to a work platform. The work platform comprises a first scaffold having a first end and a second end and a plane upon which a user can stand. The work platform comprises a first leg assembly rotatably attached with bolts to the first end of the first scaffold having a first rail and a second rail and a rung attached to the first rail and the second rail, the first leg assembly in a folded position relative to the first scaffold and essentially in parallel the plane of the first scaffold. The work platform comprises a second leg assembly rotatably attached with bolts to the second end of the first scaffold, the second leg assembly in an open position relative to the first scaffold and essentially perpendicular to the plane of the first scaffold. The work platform comprises a first hook assembly slidingly attached to the first scaffold adjacent the first end which slides between a use position where the first hook assembly extends below and outward beyond the first scaffold between the first rail and the second rail of the first leg assembly and a stowed position where the first hook assembly is retracted below the first scaffold, the first hook assembly having a hook crossbar. The work platform comprises a first latch assembly having latch assembly recesses and hooks positioned about the recesses attached to the first scaffold adjacent the second end.

The present invention pertains to a method for using a work platform system. The method comprises the steps of sliding a first hook assembly attached adjacent to a first end of a first scaffold into a use position where the first hook assembly extends below and outward beyond the first scaffold between a first rail and a second rail of a first leg assembly rotatably attached adjacent to the first end of the first scaffold from a stowed position where the first hook assembly is retracted below the first scaffold. There is the step of placing a second latch assembly attached to a second scaffold adjacent a first end of the second scaffold on the first hook assembly in the use position. There is the step of pushing down on the second scaffold so the second latch assembly engages with the first hook assembly and locks the first work platform to the second work platform with the first scaffold coplanar with the second scaffold and forming a surface.

The present invention pertains to a method for producing a work platform. The method comprises the steps of attaching a track to an underside of a scaffold. There is the step of fitting a hook assembly to the track so the first hook assembly so the hook assembly slides along the track from a stowed position into a deployed position, where the first hook assembly extends below and outward beyond the first scaffold between a first rail and a second rail of a first leg assembly rotatably attached adjacent to the first end of the first scaffold, and when the first hook assembly is in a stowed position, the first hook assembly is retracted below the first scaffold. There is the step of attaching a latch assembly to the bottom of the scaffold.

### BRIEF DESCRIPTION OF THE SEVERAL VIEWS OF THE DRAWING

In the accompanying drawings, the preferred embodiment of the invention and preferred methods of practicing the invention are illustrated in which:

FIGS. 1A-1E show multiple views of a work platform for a work platform system. In these views the legs are seen in their folded and retracted positions. The hook assembly and the latch assembly are seen on the underside of the platform. The hook assembly is in its stowed position. FIG. 1A is an underside view of the work platform. FIG. 1B is a side view of the work platform. FIG. 1C is a front view of the work platform. FIG. 1D is an overhead view of the work platform. FIG. 1E is a rear view of the work platform.

FIGS. 2A-2C show views with the legs opened and fully extended. The legs can be extended in increments between fully retracted and fully extended. The hook assembly can be seen in the stowed position. FIG. 2A is a side view of the work platform. FIG. 2B is a front view of the work platform. FIG. 2C is a perspective view of the work platform.

FIG. 3 shows a work platform with the leg at the hook assembly end opened and fully extended, and the leg at the latch assembly end closed and retracted.

FIG. 4 shows a work platform with both legs open and fully extended.

FIG. 5 shows an Ext WP about to be joined to a Base WP to form an extended work platform. The Ext WP is lowered vertically to engage the Base WP.

FIG. 6 shows the Ext WP joined to the Base WP. The latch assembly of the Ext WP automatically engages the hook assembly of the Base WP when the first and second work platforms are put into position.

FIGS. 7A and 7B show how the latch assembly engages the hook assembly: hooks on the Ext WP latch assembly retain the crossbar of the Base WP hook assembly. FIG. 7B is a underside perspective view of the work platform system. FIG. 7A is a detailed view of section A of FIG. 7B.

In FIG. 8, the latch assembly has been unlatched so the Ext WP can be separated from the Base WP.

FIGS. 9 and 10 show the Ext WP with the legs not shown for clarity.

FIG. 9 shows the latch assembly in the closed position.

FIG. 10 shows the latch assembly in the open position.

FIG. 11 shows hook assembly notches.

FIGS. 12-18 show components of the hook assembly, and the hook assembly itself in a deployed position and a stowed position.

FIG. 12 is a perspective view of the hook assembly.

FIG. 13 is a rear view of the hook assembly.

FIG. 14 is an overhead view of the hook assembly.

FIG. 15 is a side view of the hook assembly.

FIG. 16 is a perspective view of the hook assembly in a deployed position.

FIG. 17 is a perspective view of the hook assembly in the stowed position.

FIG. 18 is a front view of the hook assembly.

FIGS. 19-30 show the latch assembly in the latched position (FIGS. 19-24) and the unlatched position (FIGS. 25-30).

FIG. 19 is a right-side perspective view of the latch assembly.

FIG. 20 is an overhead view of the latch assembly.

FIG. 21 is a front view of the latch assembly.

FIG. 22 is an underside view of the latch assembly.

FIG. 23 is a left side perspective view of the latch assembly.

FIG. 24 is a side view of the latch.

FIG. 25 is a right-side perspective view of the latch assembly.

FIG. 26 is an overhead view of the latch assembly.

FIG. 27 is a front view of the latch assembly.

FIG. 28 is an underside view of the latch assembly.

FIG. 29 is a left side perspective view of the latch assembly.

FIG. 30 is a side view of the latch.

FIGS. 31-40 show an alternative embodiment of the latch assembly in the unlatched position (FIGS. 31-35) and the latched position (FIGS. 36-40).

FIG. 31 is a right underside view of the latch assembly.

FIG. 32 is a left underside view of the latch assembly.

FIG. 33 is a front view of the latch assembly.

FIG. 34 is an overhead view of the latch assembly.

FIG. 35 is a side of the latch assembly.

FIG. 36 is a right underside view of the latch assembly.

FIG. 37 is a left underside view of the latch assembly.

FIG. 38 is a front view of the latch assembly.

FIG. 39 is an overhead view of the latch assembly.

FIG. 40 is a side of the latch assembly.

FIGS. 41-44 show another alternative embodiment of the latch assembly in the unlatched position (FIGS. 41 and 42) and the latched position (FIGS. 43 and 44).

### DETAILED DESCRIPTION OF THE INVENTION

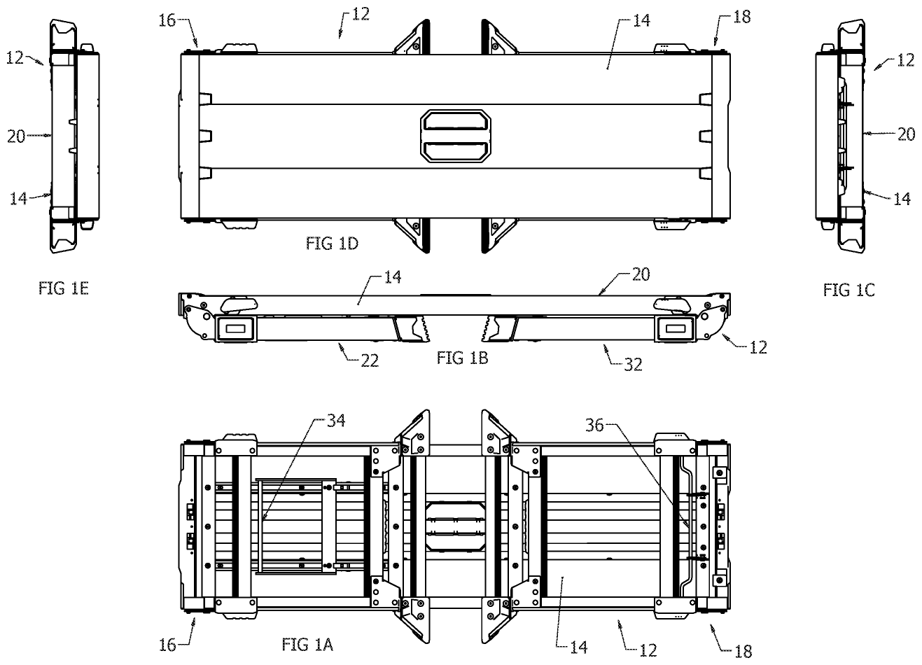

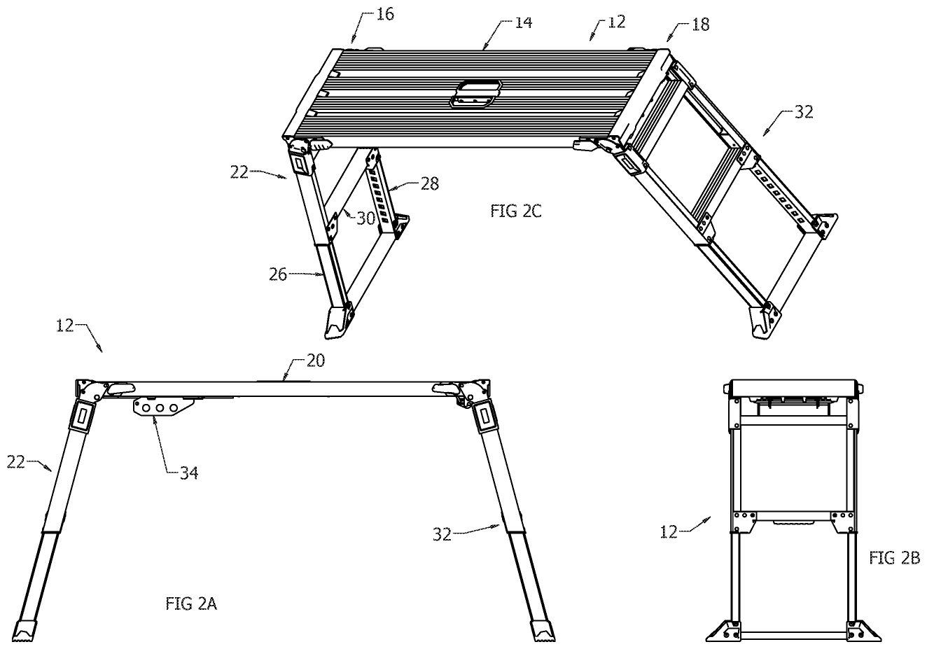

Referring now to the drawings wherein like reference numerals refer to similar or identical parts throughout the several views, and more specifically to FIGS. 1A-11 thereof, there is shown a work platform system 10. The system 10 comprises a first work platform 12. The first work platform 12 comprises a first scaffold 14 having a first end 16 and a second end 18 and a plane 20 upon which a user can stand. The first work platform 12 comprises a first leg assembly 22 rotatably attached with bolts 24 to the first end 16 of the first scaffold 14 having a first rail 26 and a second rail 28 and a rung 30 attached to the first rail 26 and the second rail 28. The first leg assembly 22 in a folded position relative to the first scaffold 14 and essentially in parallel the plane 20 of the first scaffold 14. The first work platform 12 comprises a second leg assembly 32 rotatably attached with bolts 24 to the second end 18 of the first scaffold 14, the second leg assembly 32 in an open position relative to the first scaffold 14 and essentially perpendicular to the plane 20 of the first scaffold 14. The first work platform 12 comprises a first hook assembly 34 slidingly attached to the first scaffold 14 adjacent the first end 16 which slides between a use position where the first hook assembly 34 extends below and outward beyond the first scaffold 14 between the first rail 26 and the second rail 28 of the first leg assembly 22 and a stowed position where the first hook assembly 34 is retracted below the first scaffold 14. The first work platform 12 comprises a first latch assembly 36 attached to the first scaffold 14 adjacent the second end 18.

The work platform system 10 comprises a second work platform 38. The second work platform 38 comprises a second scaffold 40 having a first end 16 and a second end 18 and a plane 20 upon which the user can stand which is flat without objects on which the user can trip. The second work platform 38 comprises a third leg assembly 42 rotatably attached with bolts 24 to the first end 16 of the second scaffold 40 having a first rail 26 and a second rail 28 and a rung 30 attached to the first rail 26 and the second rail 28 of the third leg assembly 42, the third leg assembly 42 in a closed position relative to the second scaffold 40 and essentially in parallel to the plane 20 of the second scaffold 40 when the second scaffold 40 is attached to the first scaffold 14. The second work platform 38 comprises a fourth leg assembly 44 rotatably attached with bolts 24 to the second end 18 of the second scaffold 40, the second leg assembly 32 of the second scaffold 40 in an open position relative to the second scaffold 40 and essentially perpendicular to the plane 20 of the second scaffold 40. The second work platform 38 comprises a second hook assembly 46 slidingly attached to the second scaffold 40 adjacent the second end 18 of the second scaffold 40 which slides between a use position where the second hook assembly 46 extends below and outward beyond the second scaffold 40 between the first rail 26 and the second rail 28 of the fourth leg assembly 44 and a stowed position where the first hook assembly 34 is retracted below the first scaffold 14. The second work platform 38 comprises a second latch assembly 48 attached to the second scaffold 40 adjacent the first end 16 of the second scaffold 40, the first work platform 12 locked to the second work platform 38 through the first hook assembly 34 engaging with the second latch assembly 48 and the first hook assembly 34 in the use position.

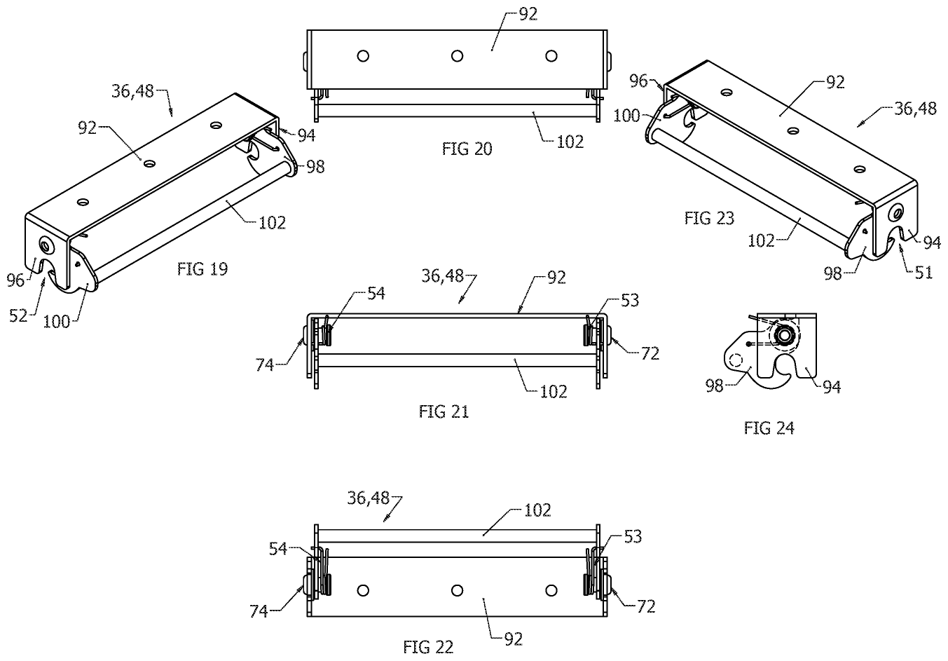

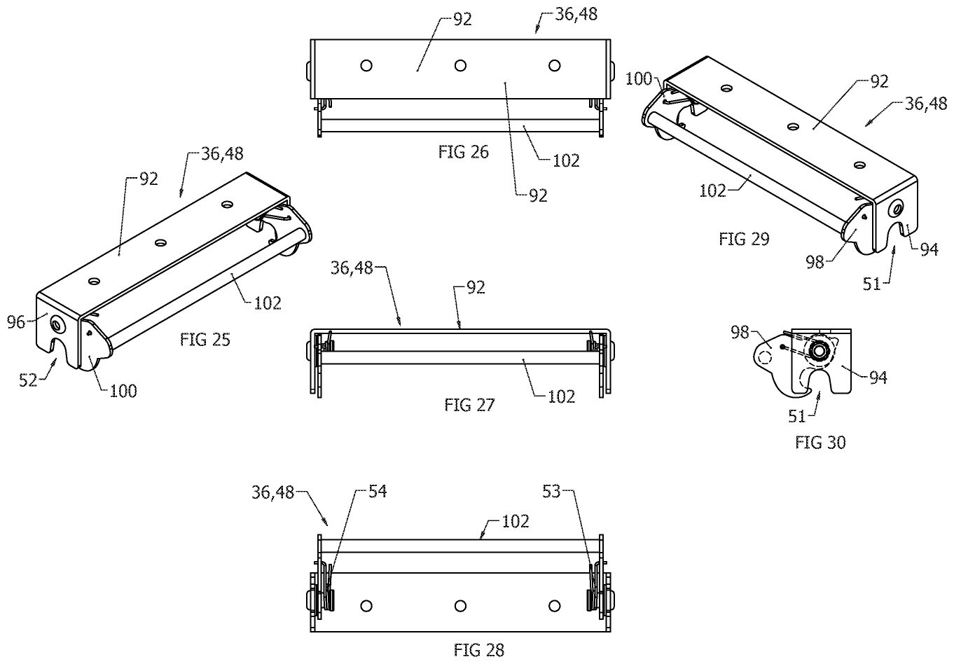

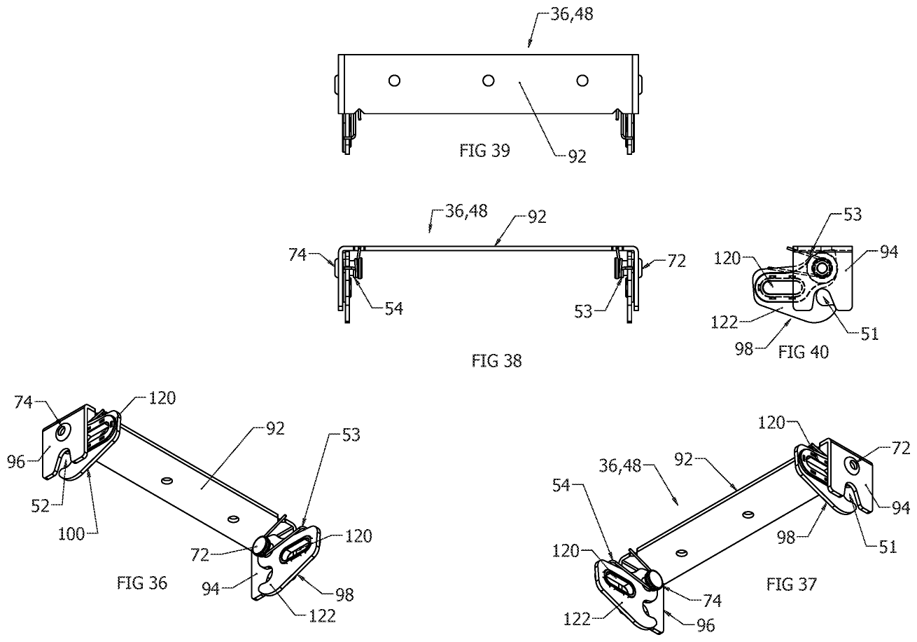

The second latch assembly 48 may have latch assembly hooks, as shown in FIGS. 19-40. The first hook assembly 34 may have a hook crossbar 50 which is locked to the latch assembly by the latch assembly hooks in the use position. The second latch assembly 48 may have recesses in which the hook crossbar 50 is locked into place by the latch assembly hooks in the use position. The second latch assembly 48 may have springs engaged with the latch assembly hooks which bias the latch assembly hooks into a closed position to lock the hook crossbar 50 into place in the recesses in the use position.

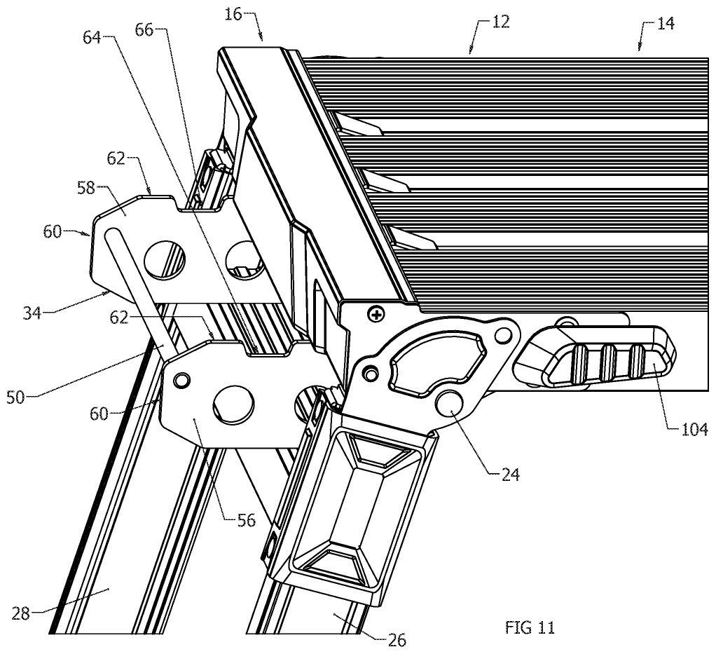

The first hook assembly 34 may have a first hook 56 and a second hook 58 in parallel and spaced relation with the first hook 56, as shown in FIGS. 11-18. The hook crossbar 50 attached to and extending between the first hook 56 and the second hook 58. The hook crossbar 50 may be attached adjacent a front end 60 of the first and second hooks 56, 58. The first hook 56 may have a top surface 62 and a first notch 64 disposed in the top surface 62 of the first hook 56, and the second hook 58 has a top surface 62 and a second notch 66 disposed in the top surface 62 of the second hook 58.

The system 10 may include a first projection 68 and a second projection 70 disposed adjacent the first end 16 of the second scaffold 40 and extending downward from the second scaffold 40, as shown in FIGS. 8-11. The first projection 68 engaged with the first notch 64 and the second projection 70 engaged with the second notch 66 in the use position. The second latch assembly 48 may automatically engage the hook crossbar 50 when the first and second projections 68, 70 are positioned in the first and second notches 64, 66, respectively. The second latch assembly 48 may include a first spring 53 of the springs in contact with a first latch assembly hook 98 of the latch assembly hooks, and a second spring 54 of the springs in contact with a second latch assembly hook 100 of the latch assembly hooks. The first spring 53 may be positioned about a first rivet 72 which rotationally attaches the first hook 56 to the first bracket 94 and the second spring 54 may be positioned about a second rivet 74 which rotationally attaches the second hook 58 to the second bracket 96.

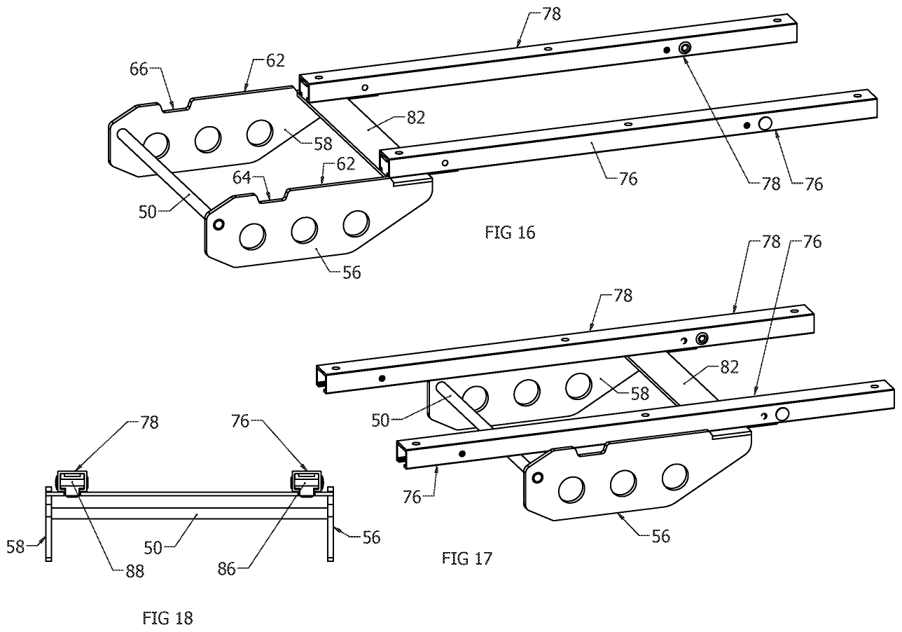

The first scaffold 14 may have a first track 76, as shown in FIGS. 16 and 17, to which the first hook assembly 34 is engaged and slides between a deployed position, where the hook crossbar 50 extends beyond the first scaffold 14, and a stowed position, where the hook crossbar 50 is retracted under the first scaffold 14. The first scaffold 14 may have a second track 78 in parallel and spaced relation with the first track 76 to which the first hook assembly 34 is engaged and slides between the deployed position and the stowed position. The first and second tracks 76, 78 may be attached to the underside 80 of the first scaffold 14. The hook assembly may have a crossplate 82 attached adjacent to and extending between a rear end 84 of the first and second hooks 56, 58. There may be a first block 86 and a second block 88 attached to the crossplate 82 which engage with and slide in the first track 76 and second track 78, respectively. At both ends of the first and second tracks 76, 78 may be stops 90 preventing the first and second blocks 86, 88 from sliding out of the first and second tracks 76, 78.

The second latch assembly 48 may have a backing plate 92 which is attached to an underside of the second scaffold 40. The second latch assembly 48 may have a first bracket 94 with a first recess 51 of the recesses which extends perpendicularly downward from the backing plate 92, and a second bracket 96 with a second recess 52 of the recesses which extends perpendicularly downward from the backing plate 92 and in parallel and spaced relation with the first bracket 94. The hook crossbar 50 disposed in the first and second recesses 51, 52 when the first work platform 12 is locked to the second work platform 38.

The second latch assembly 48 may include a first latch assembly hook 98 of the latch assembly hooks, and a second latch assembly hook 100 of the latch assembly hooks. The first latch assembly hook 98 rotationally attached to the first bracket 94, and the second latch assembly hook 100 rotationally attached to the second bracket 96 such that as the first and second latch assembly hooks 98, 100 move down against the hook crossbar 50, the hook crossbar 50 cams open the first and second latch assembly hooks 98, 100 and moves into the first and second recesses 51, 52. As the hook crossbar 50 moves past the first and second latch assembly hooks 98, 100 and into the first and second recesses 51, 52 of the second work platform 38, the first and second latch assembly hooks 98, 100 of the second work platform 38 move back into the closed position under the action of the first and second springs 53, 54 of the second work platform 38 biasing the first and second latch assembly hooks 98, 100, respectively, of the second work platform 38 into the closed position which locks the hook crossbar 50 of the first work platform 12 into place in the first and second recesses 51, 52 of the second work platform 38.

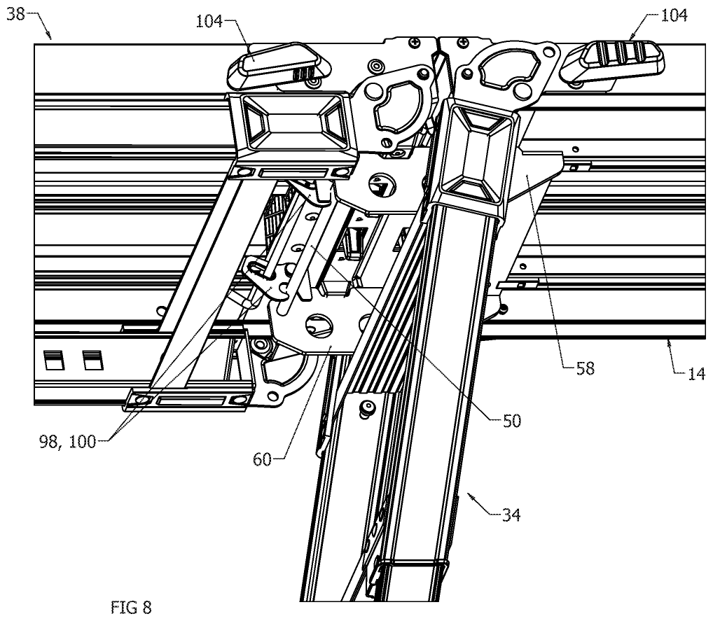

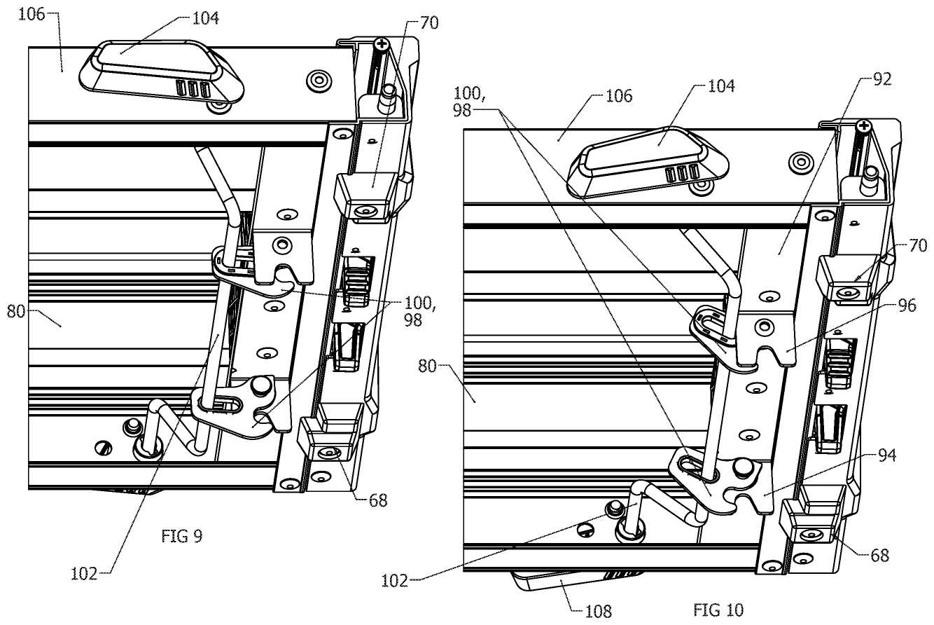

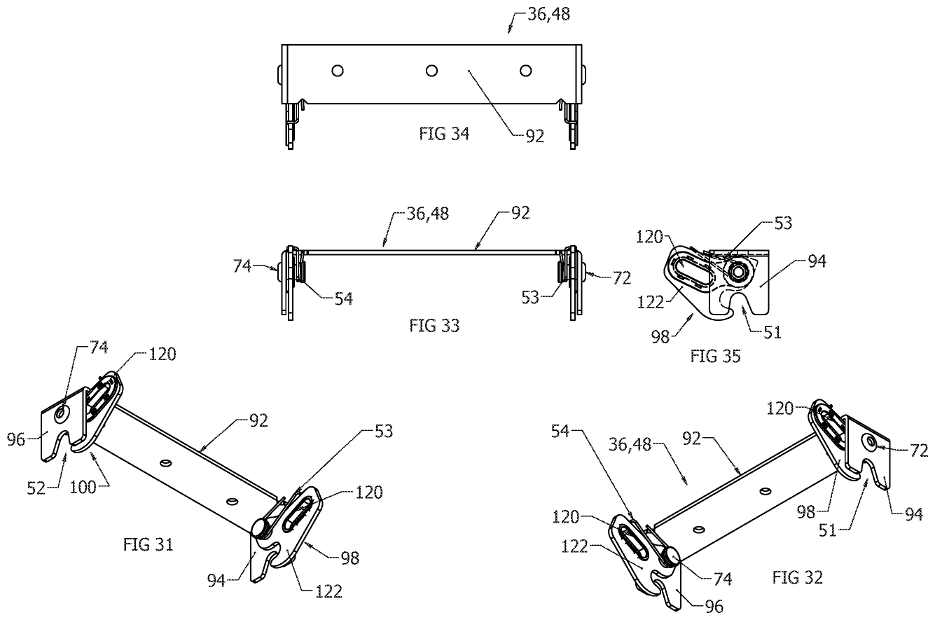

As shown in FIGS. 9 and 10, the second latch assembly 48 may include a latch crank rod 102 connected with the first and second latch assembly hooks 98, 100. The second latch assembly 48 may include a first latch lever 104 attached to the latch crank rod 102 and to the second scaffold 40 which causes the first and second latch assembly hooks 98, 100 to retract to the open position when the first latch lever 104 is moved, so the hook crossbar 50 of the first work platform 12 is released from the first and second recesses 51, 52 and the second work platform 38 can be separated from the first work platform 12. The first latch lever 104 may be disposed on the external surface of a first side 106 of the second scaffold 40. There may be a second latch lever 108 disposed on the external surface of a second side 110 of the second scaffold 40 opposing the first side 106. If desired, the leg assemblies may be extended in height, as described in U.S. patent application Ser. No. 11/049,453; and 63/305,210, incorporated by reference herein. The leg assemblies may be rotatably attached to the scaffold using pinch locks, as described in U.S. patent applications 63/305,210; and Ser. No. 17/362,901, incorporated by reference herein. The latch crank rod 102 is attached to and extends between the first and second latch levers, passing through the slot 120 in the body 122 of each latch assembly hook, as shown in FIGS. 31-40. The latch crank rod 102 has a first section which is directly connected to the first latch lever and extends through the first side 106 of the second scaffold 40, a second section directly attached to and at an angle with the first section, the third section directly attached to and at an angle with the second section, a fourth section directly attached to and added an angle with the third section, and a fifth section directly attached to and at an angle with the fourth section. The fifth section is directly attached to the second latch lever 108 and extends through the second side 110 of the second scaffold 40. The third section extends directly through the slot 120 and the body 122 of each latch assembly hook. The latch crank rod 102 is used with the latch assembly embodiment shown in FIGS. 31-40. The first and second work platforms each may support at least 250 lbs. of load and over 500 lbs. of load. The work platforms safely support a typical person standing on the work platform without buckling or failing in some way.

The present invention pertains to a first work platform 12. The first work platform 12 comprises a first scaffold 14 having a first end 16 and a second end 18 and a plane 20 upon which a user can stand. The first work platform 12 comprises a first leg assembly 22 rotatably attached with bolts 24 to the first end 16 of the first scaffold 14 having a first rail 26 and a second rail 28 and a rung 30 attached to the first rail 26 and the second rail 28. The first leg assembly 22 in a folded position relative to the first scaffold 14 and essentially in parallel the plane 20 of the first scaffold 14. The first work platform 12 comprises a second leg assembly 32 rotatably attached with bolts 24 to the second end 18 of the first scaffold 14, the second leg assembly 32 in an open position relative to the first scaffold 14 and essentially perpendicular to the plane 20 of the first scaffold 14. The first work platform 12 comprises a first hook assembly 34 slidingly attached to the first scaffold 14 adjacent the first end 16 which slides between a use position where the first hook assembly 34 extends below and outward beyond the first scaffold 14 between the first rail 26 and the second rail 28 of the first leg assembly 22 and a stowed position where the first hook assembly 34 is retracted below the first scaffold 14. The first work platform 12 comprises a first latch assembly 36 attached to the first scaffold 14 adjacent the second end 18. The first hook assembly 34 having a hook crossbar 50. The first work platform 12 comprises a first latch assembly 36 having latch assembly recesses 51, 52 and latch assembly hooks 98, 100 positioned about the recesses attached to the first scaffold 14 adjacent the second end 18.

The present invention pertains to a method for using a work platform system 10. The method comprises the steps of sliding a first hook assembly 34 attached adjacent to a first end 16 of a first scaffold 14 into a use position where the first hook assembly 34 extends below and outward beyond the first scaffold 14 between a first rail 26 and a second rail 28 of a first leg assembly 22 rotatably attached adjacent to the first end 16 of the first scaffold 14 from a stowed position where the first hook assembly 34 is retracted below the first scaffold 14. There is the step of placing a second latch assembly 48 attached to a second scaffold 40 adjacent a first end 16 of the second scaffold 40 on the first hook assembly 34 in the use position. There is the step of pushing down on the second scaffold 40 so the second latch assembly 48 engages with the first hook assembly 34 and locks the first work platform 12 to the second work platform 38 with the first scaffold 14 coplanar with the second scaffold 40 and forming a surface.

The present invention pertains to a method for producing a work platform. The method comprises the steps of attaching a track to an underside of a scaffold. There is the step of fitting a hook assembly to the track so the first hook assembly 34 so the hook assembly slides along the track from a stowed position into a deployed position, where the first hook assembly 34 extends below and outward beyond the first scaffold 14 between a first rail 26 and a second rail 28 of a first leg assembly 22 rotatably attached adjacent to the first end 16 of the first scaffold 14, and when the first hook assembly 34 is in a stowed position, the first hook assembly 34 is retracted below the first scaffold 14. There is the step of attaching a latch assembly to the bottom of the scaffold.

Additional work platforms may be added in series to the first and second work platforms 12, 38 in the same way as described above through each of their respective latch assemblies and hook assemblies.

Referring to FIG. 8, once the hook assembly is in the deployed position of the first work platform 12, the latch assembly hooks of the latch assembly of the second work platform 38 is positioned over the hook assembly crossbar. The end of the second work platform 38 with the latch assembly is pressed down or dropped which causes the hook assembly crossbar to cam open the latch assembly hooks and moved into the recesses of the latch brackets. As the hook assembly crossbar moves past the latch assembly hooks and into the recesses of the latch brackets, the latch assembly hooks move back into the closed position under the action of springs biasing them into the closed position and locks the hook assembly crossbar into place in the latch assembly recesses. Additionally, the projections of the second work platform 38 seat themselves in the hook assembly notches, to provide further stability and secure connection between the scaffolds of the first and second work platforms 12, 38.

To separate the second work platform 38 from the first work platform 12, one or both of the latch levers are rotated downwards, causing the latch crank rod 102 attached to the latch lever and connected with the latch assembly hooks to retract the latch assembly hooks. With the latch assembly hooks retracted, the second work platform 38 is free to be lifted off of the hook assembly of the first work platform 12 and separated from the first work platform 12.

FIGS. 1A-1E show multiple views of a work platform of a work platform system 10. In these views the legs are seen in their folded and retracted positions. The hook assembly and the latch assembly are seen on the underside of the platform. The hook assembly is in its stowed position.

FIGS. 2A-2C show views with the legs opened and fully extended. The legs can be extended in increments between fully retracted and fully extended. The hook assembly can be seen in the stowed position.

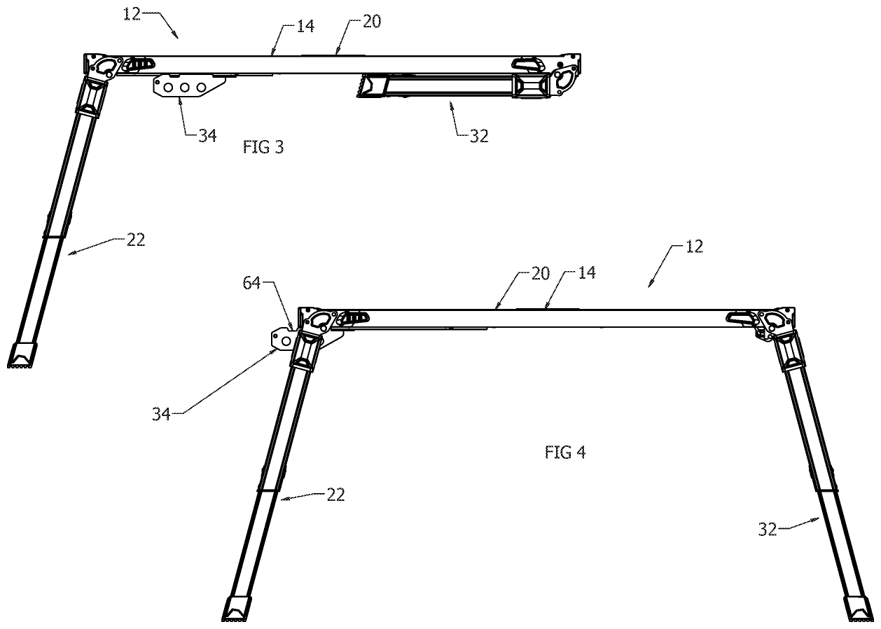

FIG. 3 shows a work platform with the leg at the hook assembly end opened and fully extended, and the leg at the latch assembly end closed and retracted. This configuration is called an “Ext WP” configuration.

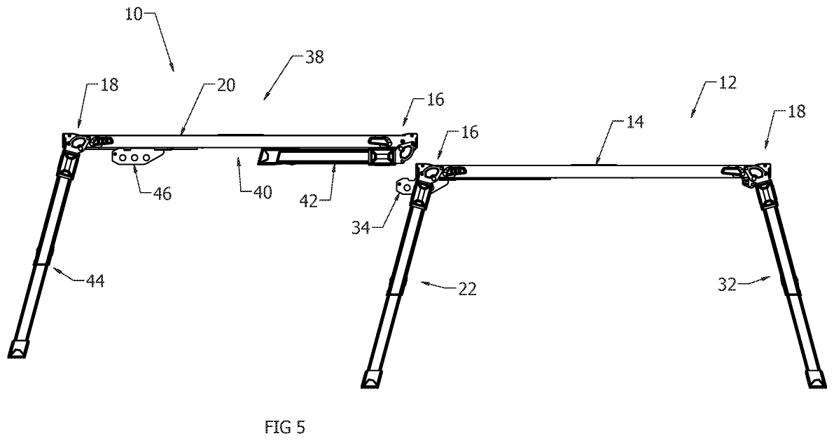

FIG. 4 shows a work platform with both legs open and fully extended. Also, the hook assembly has been slid from its stowed position to its deployed position. This configuration is called a “Base WP” configuration. Notches in the hook assembly can be seen, also in FIG. 11.

FIG. 5 shows an Ext WP about to be joined to a Base WP to form an extended work platform. The Ext WP is lowered vertically to engage the Base WP.

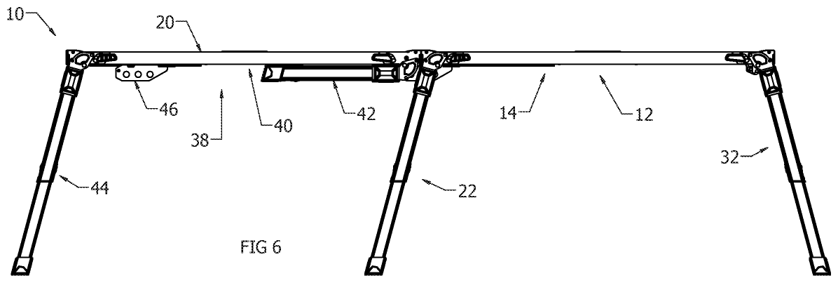

FIG. 6 shows the Ext WP joined to the Base WP. The latch assembly of the Ext WP automatically engages the hook assembly of the Base WP when the first and second work platforms 12, 38 are put into position.

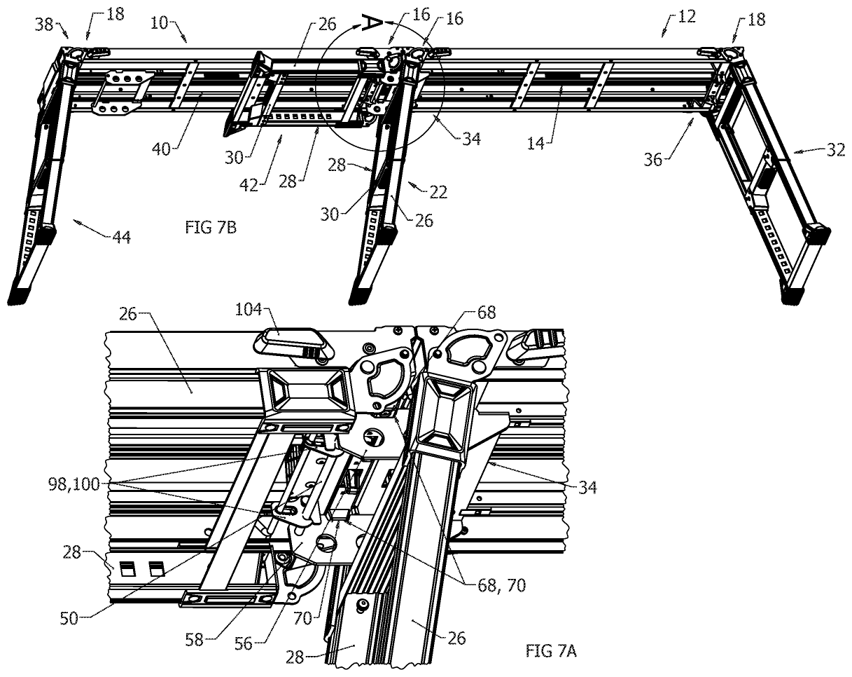

FIGS. 7A and 7B show how the latch assembly engages the hook assembly: hooks on the Ext WP latch assembly retain the crossbar of the Base WP hook assembly. Notice that projections on the EXT WP fit into notches in the hook assembly of the Base WP. These projections are shown in FIGS. 9 and 10. The notches are seen in FIG. 11.

In FIG. 8, the latch assembly has been unlatched so the Ext WP can be separated from the Base WP. This unlatching is accomplished by the user pressing down on a latch lever on the side of the platform. As seen in FIG. 10, there is a latch lever on both sides of the platform.

FIGS. 9 and 10 show the Ext WP with the legs not shown for clarity. It can be seen that pressing down on either latch lever causes the latch crank rod 102 to rotate, which in turn rotates the latch assembly hooks to their open position.

The projections seen in FIGS. 9 and 10 and the notches seen in FIG. 11 interact to provide a visual guarantee that the Ext WP is securely engaged with the Base WP: the projections must fit into the hook assembly notches in order for the latch assembly to engage the hook assembly. If the Ext WP and the Base WP are not properly aligned and the projections are not able to seat into the notches, then the deck of the Ext WP will stick up above the deck of the Base WP. This provides a visual cue that the Ext WP is not properly latched to the hook assembly of the Base WP.

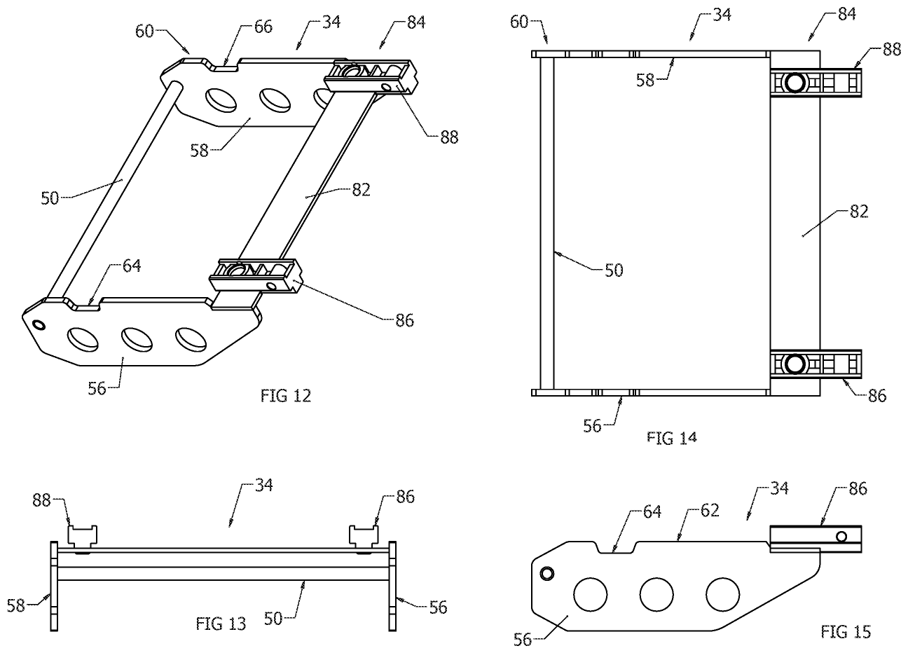

FIGS. 12-18 show components of the hook assembly, and the hook assembly itself in a deployed position and a stowed position.

FIGS. 19-30 show the latch assembly in the unlatched position and the latched position.

FIGS. 31-40 show an alternative embodiment of the latch assembly in the unlatched position and the latched position.

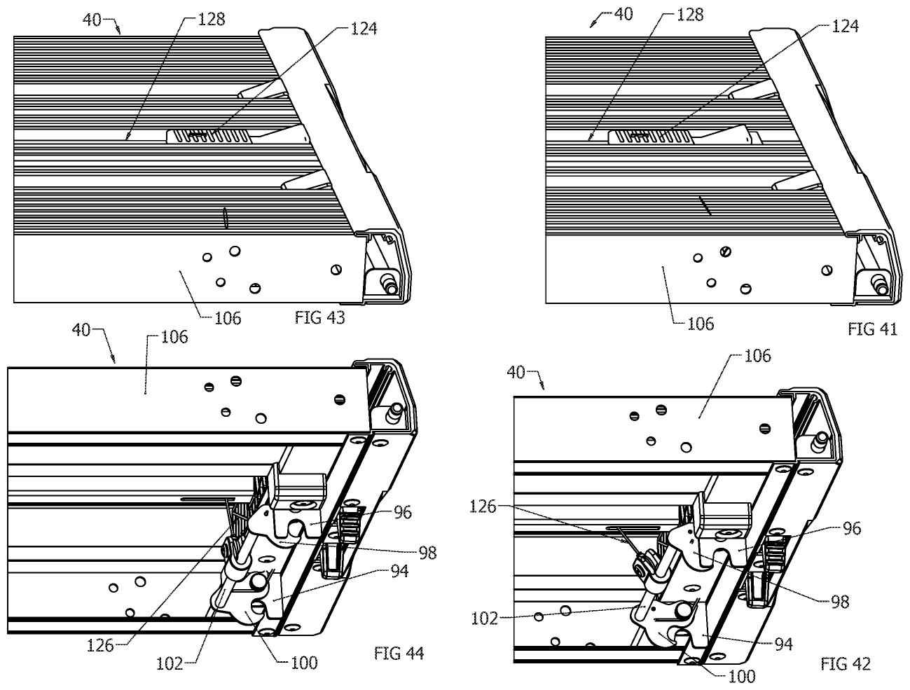

FIGS. 41-44 show another alternative embodiment of the latch assembly in the unlatched position and the latched position.

In an alternative embodiment of the work platform, FIGS. 41 and 42 show an alternative latch actuation embodiment. The legs are not shown for clarity. A sliding latch button 124 on top of the second scaffold is connected by a cable 126 to the second latch assembly on the underside of the second scaffold. FIGS. 41 and 42 show the latch assembly in the latched position. The latch assembly embodiment shown in FIGS. 19-30 is used with the sliding latch button and cable.

In FIGS. 43 and 44, the latch button has been slid to the unlatched position. The cable has pulled up on the second latch assembly causing the latch assembly hooks to move to the unlatched or open position. Other than the latch actuation details described here, this work platform embodiment operates in the same manner as the work platform embodiment described above. The cable 126 extends from the latch button 124, where it is attached, to the latch crank rod 102, where it is attached. The movement of the latch button 124 acts similar to the latch levers, causing the latch crank rod 102 to move and thus to move the first and second latch hooks into the open position. The latch springs operate in the same way, as described above, biasing the first and second latch hooks into the closed position and the latch button 124 back into the latched position. In this embodiment, the latch crank rod 102 is simply a single section beginning and ending at and between the first and second latch brackets, essentially corresponding to the third section of the latch crank rod 102 in the other embodiment. The sliding latch button 124 fits into a groove 128 in the second scaffold had about a center between the first and second sides of the second scaffold 40 so it does not protrude above the plane 20 and possibly cause the user to trip.

The user merely presses the second work platform 38 down onto the hook crossbar 50 of the first hook assembly 34 of the first work platform 12. The second latch assembly 48 on the second work platform 38 automatically engages the first hook assembly 34 of the first work platform 12. This is a very easy procedure. An additional feature is the work platform of the system 10 provides a visual cue to let the user know that the two work platforms are properly connected, the projections 68, 70 seated in the notches 64, 66. By opening the latch assembly, the two work platforms are easily separated.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A work platform system comprising:
a first work platform comprising:
a first scaffold having a first end and a second end and a plane upon which a user can stand;
a first leg assembly rotatably attached with bolts to the first end of the first scaffold having a first rail and a second rail and a rung attached to the first rail and the second rail, the first leg assembly in a folded position relative to the first scaffold and essentially in parallel with the plane of the first scaffold;
a second leg assembly rotatably attached with bolts to the second end of the first scaffold, the second leg assembly in an open position relative to the first scaffold and essentially perpendicular to the plane of the first scaffold;
a first hook assembly slidingly attached to the first scaffold adjacent the first end which slides between a use position where the first hook assembly extends below and outward beyond the first scaffold between the first rail and the second rail of the first leg assembly and a stowed position where the first hook assembly is retracted below the first scaffold;
a first latch assembly attached to the first scaffold adjacent the second end;
a second work platform comprising:
a second scaffold having a first end and a second end and a plane upon which the user can stand which is flat without objects on which the user can trip;
a third leg assembly rotatably attached with bolts to the first end of the second scaffold having a first rail and a second rail and a rung attached to the first rail and the second rail of the third leg assembly, the third leg assembly in a closed position relative to the second scaffold and essentially in parallel to the plane of the second scaffold when the second scaffold is attached to the first scaffold;
a fourth leg assembly rotatably attached with bolts to the second end of the second scaffold, the second leg assembly of the second scaffold in an open position relative to the second scaffold and essentially perpendicular to the plane of the second scaffold;
a second hook assembly slidingly attached to the second scaffold adjacent the second end of the second scaffold which slides between a use position where the second hook assembly extends below and outward beyond the second scaffold between the first rail and the second rail of the fourth leg assembly and a stowed position where the second hook assembly is retracted below the second scaffold; and
a second latch assembly attached to the second scaffold adjacent the first end of the second scaffold, the first work platform locked to the second work platform through the first hook assembly engaging with the second latch assembly and the first hook assembly in the use position.

2. The system of claim 1 wherein the second latch assembly has latch assembly hooks.

3. The system of claim 2 wherein the first hook assembly has a hook crossbar which is locked to the latch assembly by the latch assembly hooks in the use position.

4. The system of claim 3 wherein the second latch assembly has recesses in which the hook crossbar is locked into place by the latch assembly hooks in the use position.

5. The system of claim 4 wherein the second latch assembly has springs engaged with the latch assembly hooks which bias the latch assembly hooks into a closed position to lock the hook crossbar into place in the recesses in the use position.

6. The system of claim 5 wherein the first hook assembly has a first hook and a second hook in parallel and spaced relation with the first hook, the hook crossbar attached to and extending between the first hook and the second hook.

7. The system of claim 6 wherein the first hook has a top surface and a first notch disposed in the top surface of the first hook, and the second hook has a top surface and a second notch disposed in the top surface of the second hook.

8. The system of claim 7 including a first projection and a second projection disposed adjacent the first end of the second scaffold and extending downward from the second scaffold, the first projection engaged with the first notch and the second projection engaged with the second notch in the use position.

9. The system of claim 8 wherein the second latch assembly automatically engages the hook crossbar when the first and second projections are positioned in the first and second notches, respectively.

10. The system of claim 9 wherein the second latch assembly includes a first spring of the springs in contact with a first latch assembly hook of the latch assembly hooks, and a second spring of the springs in contact with a second latch assembly hook of the latch assembly hooks.

11. The system of claim 10 wherein the first scaffold has a first track to which the first hook assembly is engaged and slides between a deployed position, where the hook crossbar extends beyond the first scaffold, and a stowed position, where the hook crossbar is retracted under the first scaffold.

12. The system of claim 11 wherein the first scaffold has a second track in parallel and spaced relation with the first track to which the first hook assembly is engaged and slides between the deployed position and the stowed position.

13. The system of claim 12 wherein the second latch assembly has a backing plate which it is attached to an underside of the second scaffold, a first bracket with a first recess of the recesses which extends perpendicularly downward from the backing plate, and a second bracket with a second recess of the recesses which extends perpendicularly downward from the backing plate and in parallel and spaced relation with the first bracket, the hook crossbar disposed in the first and second recesses when the first work platform is locked to the second work platform.

14. The system of claim 13 wherein the second latch assembly includes a first latch assembly hook of the latch assembly hooks, and a second latch assembly hook of the latch assembly hooks, the first latch assembly hook rotationally attached to the first bracket, and the second latch assembly hook rotationally attached to the second bracket such that as the first and second latch assembly hooks move down against the hook crossbar, the hook crossbar cams open the first and second latch assembly hooks and moves into the first and second recesses, as the hook crossbar moves past the first and second latch assembly hooks and into the first and second recesses of the second work platform the first and second latch assembly hooks of the second work platform move back into the closed position under the action of the first and second springs of the second work platform biasing the first and second latch assembly hooks, respectively, of the second work platform into the closed position which locks the hook crossbar of the first work platform into place in the first and second recesses of the second work platform.

15. The system of claim 14 wherein the second latch assembly includes a latch crank rod connected with the first and second latch assembly hooks, and a first latch lever attached to the latch crank rod and to the second scaffold which causes the first and second latch assembly hooks to retract to the open position when the first latch lever is moved, so the hook crossbar of the first work platform is released from the first and second recesses and the second work platform can be separated from the first work platform.

16. The system of claim 15 wherein the first and second tracks are attached to an underside of the first scaffold.

17. The system of claim 16 wherein the first hook assembly has a crossplate attached adjacent to and extending between a rear end of the first and second hooks, and a first block and a second block attached to the crossplate which engage with and slide in the first track and second track, respectively.

18. The system of claim 14 wherein the second latch assembly includes a sliding latch button on a top surface of the second scaffold which is connected by a cable to the second latch assembly on the underside of the second scaffold, the latch button causing the second latch assembly to enter an open position to release the hook bar.

19. A method for using a work platform system comprising the steps of:
sliding a first hook assembly attached adjacent to a first end of a first scaffold into a use position where the first hook assembly extends below and outward beyond the first scaffold between a first rail and a second rail of a first leg assembly rotatably attached adjacent to the first end of the first scaffold from a stowed position where the first hook assembly is retracted below the first scaffold;
placing a second latch assembly attached to a second scaffold adjacent a first end of the second scaffold on the first hook assembly in the use position; and
pushing down on the second scaffold so the second latch assembly engages with the first hook assembly and locks the first work platform to the second work platform with the first scaffold coplanar with the second scaffold and forming a surface.

20. A method for producing a work platform comprising the steps of:
attaching a track to an underside of a scaffold;
fitting a hook assembly to the track so the first hook assembly so the hook assembly slides along the track from a stowed position into a deployed position, where the first hook assembly extends below and outward beyond the first scaffold between a first rail and a second rail of a first leg assembly rotatably attached adjacent to the first end of the first scaffold, and when the first hook assembly is in a stowed position, the first hook assembly is retracted below the first scaffold; and
attaching a latch assembly to the bottom of the scaffold.

21. A work platform comprising:
a first scaffold having a first end and a second end and a plane upon which a user can stand;
a first leg assembly rotatably attached with bolts to the first end of the first scaffold having a first rail and a second rail and a rung attached to the first rail and the second rail, the first leg assembly in a folded position relative to the first scaffold and essentially in parallel the plane of the first scaffold;
a second leg assembly rotatably attached with bolts to the second end of the first scaffold, the second leg assembly in an open position relative to the first scaffold and essentially perpendicular to the plane of the first scaffold;
a first hook assembly slidingly attached to the first scaffold adjacent the first end which slides between a use position where the first hook assembly extends below and outward beyond the first scaffold between the first rail and the second rail of the first leg assembly and a stowed position where the first hook assembly is retracted below the first scaffold, the first hook assembly having a hook crossbar, and
a first latch assembly having latch assembly recesses and hooks positioned about the recesses attached to the first scaffold adjacent the second end.
